(19) United States
(12) Patent Application Publication
(10) Pub. No.: US 2004/0060102 A1
(43) Pub. Date: Apr. 1, 2004

(54) Garments for biological, chemical and fire protection

(75) Inventor: Michael J. Brookman, Branford, CT (US)

Correspondence Address: FISH & NEAVE, 1251 AVENUE OF THE AMERICAS, 50TH FLOOR, NEW YORK, NY, 10020-1105, US

(73) Assignee: INTERSPIRO, INC., Branford, CT

(21) Appl. No.: 10/412,469

(22) Filed: Apr. 9, 2003

Related U.S. Application Data
(60) Provisional application No. 60/371,988, filed on Apr. 10, 2002.

(51) Int. Cl. A41D 13/00; A62B 17/00

(52) U.S. Cl. 2/457; 2/202; 2/115; 2/227; 2/239

(57) ABSTRACT

The present invention relates to protective fabric that protects first-response personnel, like firefighters, who rush into disaster areas immediately after such events occur. In particular, this invention relates to garments such as hoods (like a balaclava-shaped hood) made from a multi-layer protective fabric that includes at least two active layers, that may provide biological, chemical and fire protection to first-response personnel. The balaclava-shaped hood may be integrated with a protective mask to create fully-encapsulated protection. This protective fabric may include an inner layer, an active middle layer and an active outer layer. The inner layer may be comprised of a stretchable fabric. The middle layer may provide an adsorptive barrier to chemicals, such as terror agent, Mustard gas or other such agents. The outer layer may be comprised of a flame-resistant fiber-product.

### CROSS-REFERENCE TO RELATED APPLICATION

This application claims the benefit of U.S. Provisional Application No. 60/371,988, filed Apr. 10, 2002, which is hereby incorporated herein by reference in its entirety.

### BACKGROUND OF THE INVENTION

As a result of recent terrorist attacks, there has been a heightened concern for the protection of first-response personnel. When entering these disaster sites, first-response personnel may be presented with both fire hazards and biological and chemical hazards. These biological and chemical hazards may come in the form of chemical warfare agents or as a result of the devastation of a disaster area. For example, at the terrorist attacks at the World Trade Center in New York City on Sep. 11, 2001, the combination of the intense heat from the fires and the collapsing of the two 110-story buildings increased the likelihood of an asbestos contamination.

First-response personnel protective gear currently comes as firefighter suits or fully encapsulated chemical protective suits. Firefighter suits do not satisfy the aforementioned dangers because they lack the protection from biological and chemical hazards. Fully encapsulated chemical protective suits do not satisfy the aforementioned dangers because they lack protection from fire hazards. Chemical protective suits are also bulky, which minimizes a first-responder's ability to assist those in need.

Military personnel also lack proper protection during military missions from attacks involving biological, chemical and fire hazards. Like first-response personnel, mobility may be crucial in escaping from such hazards to save their lives and the lives of others. In current chemical protective suits, military personnel need to concern themselves with sudden and sharp movements that may tear their suits, thus eliminating their protective purpose.

Improvements to first-response protective gear are desirable to alleviate these and other drawbacks. Accordingly, new first-response protective gear are provided.

### SUMMARY OF THE INVENTION

This invention relates generally to headgear for first-response personnel, like firefighters, who rush into biological, chemical and fire hazard areas immediately after such events occur. In particular, this invention relates to hoods, such as a balaclava-shaped hood integrated with a protective mask, that may provide biological, chemical and fire protection to first-response personnel.

The hood may be balaclava-shaped and may include distinct layers of protection from the different hazards faced by a first-response personnel. An inner layer may be comprised of a stretchable fabric. A middle layer may be comprised of carbon spheres which absorb a biological or chemical agent and may provide an adsorptive barrier to chemicals before it reaches the inner layer. Alternatively, the middle layer may be comprised of a blocking agent that blocks transmission of biological or chemical agents through the layer. An outer layer may be comprised of a fiber-product that has flame-resistant properties. An example of such a product is Dupont's NOMEX®.

Persons skilled in the art will appreciate that the principles of the present invention may be used to construct different apparel, such as, but not limited to, a shirt, pair of pants, glove, sock, jacket, hat, and blanket.

### BRIEF DESCRIPTION OF THE DRAWINGS

FIG. 1 shows an illustration of a known fully encapsulated chemical protective suit;

FIG. 2 shows an illustration of firefighter outerwear typically worn by firefighters;

FIG. 3 shows an illustration of the undergarments typically worn by firefighters;

FIG. 4 shows an illustration of a frontal view of a hood that provides first-response personnel with protection from biological, chemical and fire hazards in accordance with the principles of the present invention;

FIG. 5a shows an illustration of a profile view of a hood that provides first-response personnel with protection from biological, chemical and fire hazards in accordance with the principles of the present invention;

FIG. 5b shows an illustration of a profile view of a hood integrated with a protective mask that provides first-response personnel with protection from biological, chemical and fire hazards in accordance with the principles of the present invention; and

FIG. 6 shows an illustrative cross-sectional view of the protective hood of FIGS. 4 and 5 constructed in accordance with the principles of the present invention.

### DETAILED DESCRIPTION OF THE INVENTION

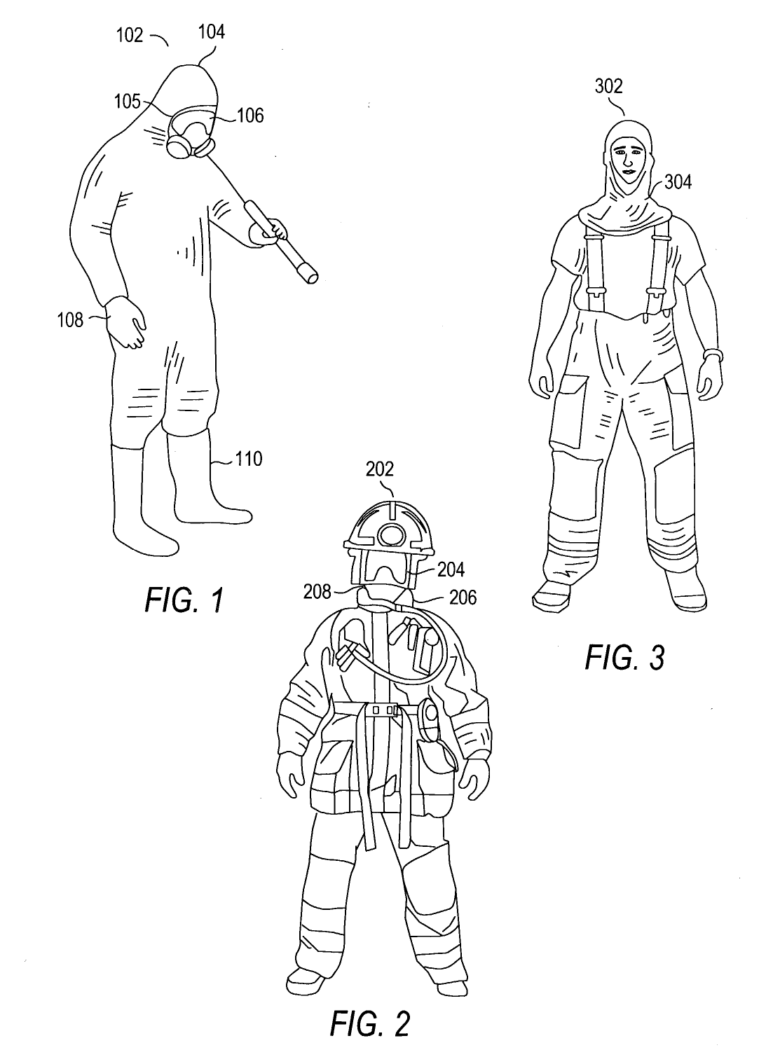

Current outerwear worn by first-response personnel, such as firefighters, is designed to protect them from heat, flame and impact injuries. These first-responders, however, do not have adequate protection from the biological and chemical hazards that may also be present at the fire or disaster site. At present, the only protection from biological and chemical hazards are fully encapsulated biohazard suits, such as suit 102 shown in FIG. 1. These suits, however, may not be practical for disaster applications because: (1) they are vulnerable to flames and intense heat; and (2) they may not provide first-responders with the necessary protection against impact injuries. This is problematic, particularly in view of recent terrorist attacks in which materials, such as asbestos, may be present. Thus, a need has arisen for additional protection, such as from chemical hazards, when first-responders approach disaster sites.

FIG. 1 shows an illustration of a known fully encapsulated chemical protective suit 102. Fully encapsulated suit 102 may be comprised of hood 104, mask 106, gloves 108 and boots 110. Openings, or interfaces, that may exist between the different parts of suit 102 may be protected from chemicals by, for example, using sealing tape. Interface 105 between hood 104 and mask 106 may be sealed with tape or alternatively cinched to effect a seal. Fully encapsulated suit 102, however, may be ineffective for first-response personnel because it is likely to be more vulnerable to hazards associated with firefighting, such as flames, intense heat and impact injuries than traditional firefighting gear. Moreover, fully encapsulated suit 102 may not provide first-responders with the dexterity necessary to sufficiently deal with the chaos that is often found in disaster areas because of its bulk and operating limitations.

One area of the body that may be particularly susceptible to biological and chemical hazards is the cranial, or head region. While this region is likely the most critical for cutaneous protection, it is also the most difficult to efficiently and effectively protect because it is the most dynamic for the personnel responding to the fire or disaster area in terms of the relative movement of the torso, head and neck.

FIG. 2 shows an illustration of firefighter outerwear 202 presently used for protection of emergency personnel. Firefighter outerwear 202 may include mask 204 and coat collar 206. Interface 208 between mask 204 and coat collar 206 may be sealed using sealing tape to protect parts of the body exposed at this interface.

In addition to sealing interface 208 with sealing tape, one might seal interface 208 with a zipper, buttons, by sewing, or other sealing means. Each of these sealing means is ineffective because openings, even if these openings are small, exist and leave first-response personnel susceptible to biological, chemical and even possibly fire hazards.

FIG. 3 shows an illustration of firefighter under-garments 302 that are presently used for protection by firefighters. Under-garments 302 are often used in conjunction with outerwear 202. Firefighter undergarments 302 may include flame-resistant hood 304 to further protect the body, especially in areas left fully or partially exposed by outerwear 202, and especially by interface 208. Despite using flame-resistant hood 304, mask 204, coat collar 206 and sealing tape, a firefighter may still be vulnerable to biological and chemical hazards because the safeguards shown in FIGS. 2 and 3 are not designed to protect these personnel from such hazards.

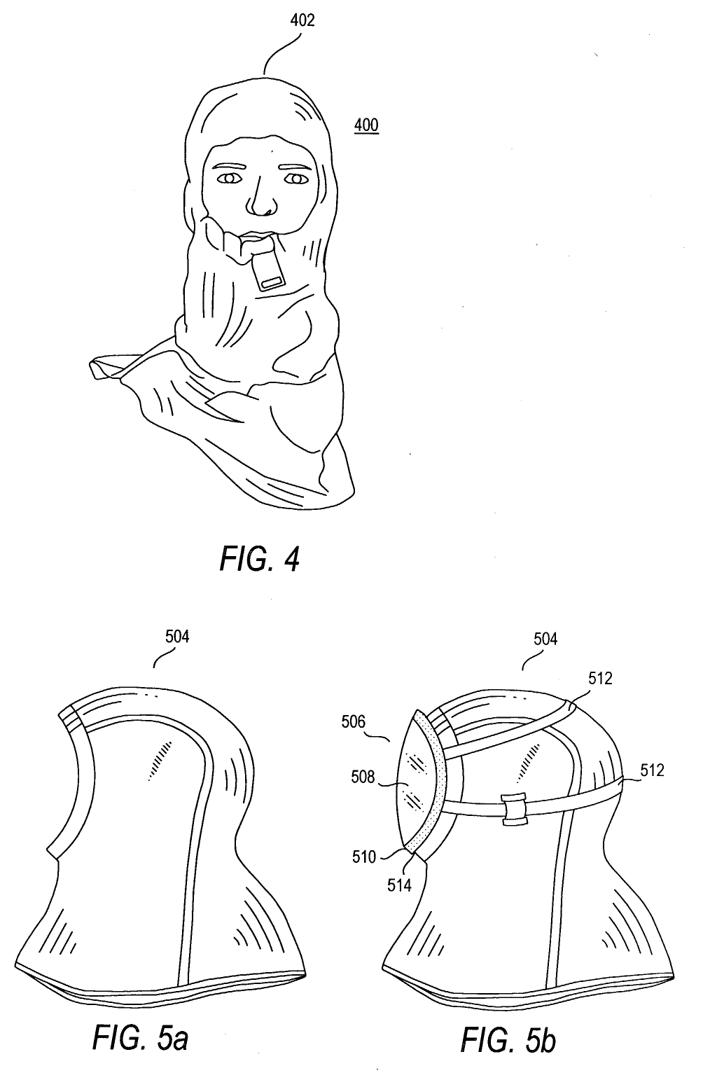

The present invention relates to a hood that provides first-response personnel with protection from biological, chemical and fire hazards in the cranial region. FIGS. 4 and 5a show illustrations of a balaclava-shaped hood 400 including frontal view 402 and profile view 504, respectively. The balaclava-shaped hood, when integrated with a protective mask, provides covering and protection to the head, face, neck and parts of the chest, back and shoulders while still allowing openings for the personnel to breathe and see.

FIG. 5b shows illustrative profile view 504 of a balaclava-shaped hood 400 integrated with protective mask 506. Protective mask 506 may include mask lens 508, lens frame 510 and straps 512. Protective mask 506 may provide first-response personnel with protection from biological, chemical and fire hazards. Openings, or interfaces, that may exist between balaclava-shaped hood 400 and protective mask 506 may be protected from biological, chemical and fire hazards by, for example, using sealing tape. Interface 514 between mask 508 and hood 400 may be cinched to create a seal, sealed with tape, hook and loop fasteners, snaps, buttons, zippers, by sewing, or other sealing means.

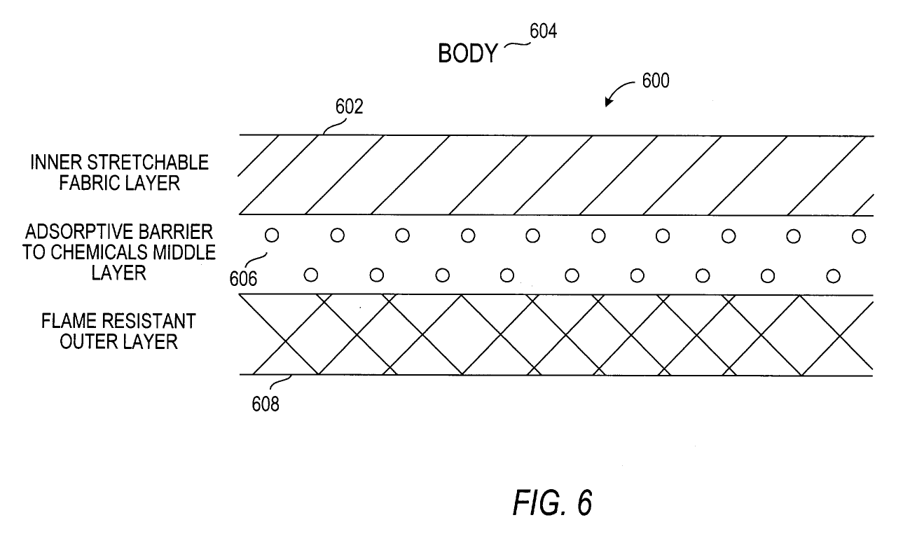

FIG. 6 shows an illustrative cross-sectional view of the composition 600 of hood 400 constructed in accordance with the present invention that provides protection from biological, chemical and fire hazards. Hood 400 may be balaclava-shaped and may include inner layer 602, middle layer 606 and outer layer 608. Inner layer 602 may be flush with body 604 (i.e., the body of the first-response personnel) and may be comprised of a stretchable fabric. Middle layer 606 may be adhered to inner layer 602 and outer layer 608. Middle layer 606 may provide an adsorptive barrier to chemicals, such as terror agent, Mustard gas or other such agents. The adsorptive barrier in this layer may be comprised of carbon spheres which absorb the chemical agent before it reaches inner layer 602. Alternatively, the middle layer may be comprised of a blocking agent, such as gas tight sheets including Teflon PTFE, PFA or other such barrier polymers, films or foils. Moreover, persons skilled in the art will appreciate that layer 606 may be formed from one or more individual layers, such as a combination of a layer of carbon spheres and a layer of a blocking agent. Outer layer 608 may be adhered to middle layer 606 and should be comprised of a fiber-product that has flame-resistant properties. An example of such a product is Dupont's NOMEX®.

In accordance with the principles of the present invention, the use of at least two active layers in the fabric—i.e., the middle layer providing protection from bio-chemical hazards, with the outer, fire hazard protective layer—provide emergency personnel with a level of protection that was previously unavailable. Moreover, the present invention provides such protection without significantly compromising movement. The combination of the three layers described above in a hood, in particular, provide the cranial region with protection against biological, chemical and fire hazards that is not available in current firefighter suits.

Persons skilled in the art will also appreciate that the principles of the present invention are applicable to protecting other portions of the body instead of, or in addition to, the cranial region. For example, gloves may be constructed in accordance with the present invention having the three-layer structure described above (including the use of at least two active layers) that provide protection from biological, chemical and fire hazards simultaneously, while minimizing the negative impact on manual dexterity. Alternatively, the principles of the present invention may also be applied to foot under-garments as a replacement for, or in addition to, socks. Moreover, the principles of the present invention may also be applied to non-garment applications, such as blankets, that may be used by first-response personnel to cover and protect victims of such disasters as they are evacuated from the site.

1. A multi-layer garment that provides protection against biological, chemical and fire hazards, comprising:
an inner layer;
an active middle layer adhered to said inner layer comprising members that act as a barrier; and
an active outer layer adhered to said middle layer comprising a flame resistant fiber-product.

2. The multi-layer garment of claim 1, wherein said inner, middle and outer layers are formed into a hood.

3. The multi-layer garment of claim 2, wherein said hood is balaclava-shaped.

4. The multi-layer garment of claim 3, further comprising a protective mask, wherein said balaclava-shaped hood is integrated with said protective mask via a sealed interface to create fully-encapsulated protection.

5. The multi-layer garment of claim 1, wherein said inner, middle and outer layers are formed into a shirt.

6. The multi-layer garment of claim 1, wherein said inner, middle and outer layers are formed into pants.

7. The multi-layer garment of claim 1, wherein said inner, middle and outer layers are formed into a glove.

8. The multi-layer garment of claim 1, wherein said inner, middle and outer layers are formed into a sock.

9. The multi-layer garment of claim 1, wherein said inner, middle and outer layers are formed into a jacket.

10. The multi-layer garment of claim 1, wherein said members act as a chemical barrier.

11. The multi-layer garment of claim 1, wherein said members act as a biological barrier.

12. The multi-layer garment of claim 1, wherein said members act as a chemical and biological barrier.

13. The multi-layer garment of claim 1, wherein said members are spherical adsorber members.

14. The multi-layer garment of claim 1, wherein said members comprise a blocking agent.

15. The multi-layer garment of claim 1, wherein said middle layer comprises a first middle layer and a second middle layer.

16. The multi-layer garment of claim 15, wherein:
said first middle layer comprises adsorber members; and
said second middle layer comprises a blocking agent.

17. The multi-layer garment of claim 1, wherein said inner layer comprises a stretchable fabric.

18. The multi-layer garment of claim 1, wherein said flame resistant fiber-product is NOMEX®.

19. The multi-layer garment of claim 1, wherein:
said inner layer comprises a stretchable fabric; and
said flame resistant fiber-product is NOMEX®.

20. A multi-layer hood that provides protection against biological, chemical and fire hazards, comprising:
an inner layer;
an active middle layer adhered to said inner layer comprising members that act as a barrier; and
an active outer layer adhered to said middle layer comprising a flame resistant fiber-product.

21. The multi-layer hood of claim 20, wherein said hood is balaclava-shaped.

22. The multi-layer hood of claim 21, further comprising a protective mask, wherein said balaclava-shaped hood is integrated with said protective mask via a sealed interface to create fully-encapsulated protection.

23. The multi-layer hood of claim 20, wherein said members act as a chemical barrier.

24. The multi-layer hood of claim 20, wherein said members act as a biological barrier.

25. The multi-layer hood of claim 20, wherein said members act as a chemical and biological barrier.

26. The multi-layer hood of claim 20, wherein said members are spherical adsorber members.

27. The multi-layer hood of claim 20, wherein said member comprises a blocking agent.

28. The multi-layer hood of claim 20, wherein said middle layer comprises a first middle layer and a second middle layer.

29. The multi-layer hood of claim 28, wherein:
said first middle layer comprises adsorber members; and
said second middle layer comprises a blocking agent.

30. The multi-layer hood of claim 20, wherein said inner layer comprises a stretchable fabric.

31. The multi-layer hood of claim 20, wherein said flamer resistant fiber-product is NOMEX®.

32. The multi-layer hood of claim 20, wherein:
said inner layer comprises a stretchable fabric; and
said flame resistant fiber-product is NOMEX®.

33. A multi-layer blanket that provides protection against biological, chemical and fire hazards, comprising:
an inner layer;
an active middle layer adhered to said inner layer comprising members that act as a barrier; and
an active outer layer adhered to said middle layer comprising a flame resistant fiber-product.

34. The multi-layer blanket of claim 33, wherein said members act as a chemical barrier.

35. The multi-layer blanket of claim 33, wherein said members act as a biological barrier.

36. The multi-layer blanket of claim 33, wherein said members act as a chemical and biological barrier.

37. The multi-layer blanket of claim 33, wherein said members are spherical adsorber members.

38. The multi-layer blanket of claim 33, wherein said members comprise a blocking agent.

39. The multi-layer blanket of claim 33, wherein said middle layer comprises a first middle layer and a second middle layer.

40. The multi-layer blanket of claim 39, wherein:
said first middle layer comprise adsorber members; and
said second middle layer comprises a blocking agent.

41. The multi-layer blanket of claim 33, wherein said inner layer comprises a stretchable fabric.

42. The multi-layer blanket of claim 33, wherein said flame resistant fiber-product is NOMEX®.

43. The multi-layer blanket of claim 33, wherein:
said inner layer comprises a stretchable fabric; and
said flame resistant fiber-product is NOMEX®.
